(19) United States
(12) Patent Application Publication
(10) Pub. No.: US 2023/0368800 A1
(43) Pub. Date: Nov. 16, 2023

(54) AUDIO ENCODING METHOD AND APPARATUS, AND AUDIO DECODING METHOD AND APPARATUS

(71) Applicant: VIVO MOBILE COMMUNICATION CO., LTD., Guangdong (CN)

(72) Inventor: Yong ZHANG, Guangdong (CN)

(21) Appl. No.: 18/351,634

(22) Filed: Jul. 13, 2023

Related U.S. Application Data
(63) Continuation of application No. PCT/CN2022/071961, filed on Jan. 14, 2022.

(30) Foreign Application Priority Data
Jan. 21, 2021 (CN) 202110080645.0

(51) Int. Cl. G10L 19/00

(52) U.S. Cl. CPC G10L 19/00

(57) ABSTRACT

An audio encoding method, an audio decoding method, an audio encoding apparatus, and an audio decoding apparatus are provided. The audio encoding method includes: determining, based on audio parameters of a to-be-encoded audio signal, a to-be-encoded sequence and a first bitstream (S101); determining a code number corresponding to each element in the to-be-encoded sequence (S102); encoding, based on the code numbers and preset coding tables corresponding to preset coding orders, the to-be-encoded sequence to obtain a second bitstream (S103); and sorting and packing the first bitstream, the second bitstream, and a third bitstream to obtain an audio encoded bitstream (S104).

### CROSS-REFERENCE TO RELATED APPLICATIONS

This application is a continuation application of PCT Application No. PCT/CN2022/071961 filed on Jan. 14, 2022, which claims priority to Chinese Patent Application No. 202110080645.0, filed in China on Jan. 21, 2021, disclosures of which are incorporated herein by reference in their entireties.

### TECHNICAL FIELD

This application pertains to the field of audio processing technologies, and specifically, relates to an audio encoding method, an audio decoding method, an audio encoding apparatus, and an audio decoding apparatus.

### BACKGROUND

The essence of audio encoding technology lies in compressing an audio signal without compromising its integrity and fidelity, without introducing any noise or distortion during the compression process.

An encoding method for encoding audio signal is to determine probability distributions of audio parameters in an audio signal, and then encode the audio signal according to the probability distributions of the audio parameters. However, different audio parameters correspond to different probability distributions. In the case of a large number of audio parameters, a large number of calculation processes are needed to determine the probability distributions of all audio parameters before audio signal encoding, which in turn leads to low encoding efficiency.

### SUMMARY

According to a first aspect, an embodiment of this application provides an audio encoding method including:
determining, based on audio parameters of a to-be-encoded audio signal, a to-be-encoded sequence and a first bitstream, where the audio parameters include a first parameter and N second parameters, N being a positive integer, the first bitstream is obtained by encoding based on the first parameter, and the to-be-encoded sequence is obtained by encoding based on the first parameter and the N second parameters;
determining a code number corresponding to each element in the to-be-encoded sequence;
encoding, based on the code numbers and preset coding tables corresponding to preset coding orders, the to-be-encoded sequence to obtain a second bitstream; and
sorting and packing the first bitstream, the second bitstream, and a third bitstream to obtain an audio encoded bitstream; where
the third bitstream is an encoded bitstream obtained based on a magnitude relationship between each element in the to-be-encoded sequence and a first preset value.

According to a second aspect, an embodiment of this application provides an audio decoding method including:
decoding an audio encoded bitstream corresponding to an audio signal to obtain a first bitstream, a second bitstream, and a third bitstream, where audio parameters of the audio signal include a first parameter and N second parameters, N being a positive integer, and the first bitstream is obtained by encoding based on the first parameter;
determining a value corresponding to the first bitstream as the first parameter;
decoding, based on preset coding tables corresponding to preset coding orders, each code value in the second bitstream to obtain a code number corresponding to each element in a to-be-encoded sequence, the to-be-encoded sequence being obtained by encoding based on the first parameter and the N second parameters;
decoding the third bitstream to obtain a magnitude relationship between each element in the to-be-encoded sequence and a first preset value;
determining the to-be-encoded sequence based on the code numbers corresponding to elements in the to-be-encoded sequence and the magnitude relationship between each element in the to-be-encoded sequence and the first preset value; and
decoding the to-be-encoded sequence based on the first parameter to obtain the N second parameters.

According to a third aspect, an embodiment of this application provides an audio encoding apparatus including:
a first determining module configured to determine, based on audio parameters of a to-be-encoded audio signal, a to-be-encoded sequence and a first bitstream, where the audio parameters include a first parameter and N second parameters, N being a positive integer, the first bitstream is obtained by encoding based on the first parameter, and the to-be-encoded sequence is obtained by encoding based on the first parameter and the N second parameters;
a second determining module configured to determine a code number corresponding to each element in the to-be-encoded sequence;
an encoding module configured to encode, based on the code numbers and preset coding tables corresponding to preset coding orders, the to-be-encoded sequence to obtain a second bitstream; and
a packing module configured to sort and pack the first bitstream, the second bitstream, and a third bitstream to obtain an audio encoded bitstream; where
the third bitstream is an encoded bitstream obtained based on a magnitude relationship between each element in the to-be-encoded sequence and a first preset value.

According to a fourth aspect, an embodiment of this application provides an audio decoding apparatus including:
a first decoding module configured to decode an audio encoded bitstream corresponding to an audio signal to obtain a first bitstream, a second bitstream, and a third bitstream, where audio parameters of the audio signal include a first parameter and N second parameters, N being a positive integer, and the first bitstream is obtained by encoding based on the first parameter;
a third determining module configured to determine a value corresponding to the first bitstream as the first parameter;
a second decoding module configured to decode, based on preset coding tables corresponding to preset coding orders, each code value in the second bitstream to obtain a code number corresponding to each element in a to-be-encoded sequence, the to-be-encoded sequence being obtained by encoding based on the first parameter and the N second parameters;
a third decoding module configured to decode the third bitstream to obtain a magnitude relationship between each element in the to-be-encoded sequence and a first preset value;
a fourth determining module configured to determine the to-be-encoded sequence based on the code numbers corresponding to elements in the to-be-encoded sequence and the magnitude relationship between each element in the to-be-encoded sequence and the first preset value; and
a fourth decoding module configured to decode the to-be-encoded sequence based on the first parameter to obtain the N second parameters.

According to a fifth aspect, an embodiment of this application provides an electronic device, where the electronic device includes a processor, a memory, and a program or instructions stored in the memory and capable of running on the processor, and when the program or instructions are executed by the processor, the steps of the method according to the first aspect are implemented, or the steps of the method according to the second aspect are implemented.

According to a sixth aspect, an embodiment of this application provides a readable storage medium, where the readable storage medium stores a program or instructions, and when the program or instructions are executed by a processor, the steps of the method according to the first aspect are implemented, or the steps of the method according to the second aspect are implemented.

According to a seventh aspect, an embodiment of this application provides a chip. The chip includes a processor and a communications interface, where the communications interface is coupled to the processor, and the processor is configured to run a program or instructions to implement the method according to the first aspect or the method according to the second aspect.

According to an eighth aspect, a computer program product is provided, where the computer program product is stored in a non-transitory storage medium, and the computer program product is executed by at least one processor to implement the method according to the first aspect or the method according to the second aspect.

### BRIEF DESCRIPTION OF DRAWINGS

To describe the technical solutions in the embodiments of this application more clearly, the following briefly describes the accompanying drawings required for describing the embodiments of this application. Apparently, the accompanying drawings in the following description show merely some embodiments of this application, and persons of ordinary skill in the art may derive other drawings from these accompanying drawings.

FIG. 1 is a schematic diagram of an application scenario of an audio encoding method according to an embodiment of this application;

FIG. 2 is a flowchart of an audio encoding method according to an embodiment of this application;

FIG. 3 is a flowchart of an audio decoding method according to an embodiment of this application;

FIG. 4 is a structural diagram of an audio encoding apparatus according to an embodiment of this application;

FIG. 5 is a structural diagram of an audio decoding apparatus according to an embodiment of this application; and

FIG. 6 is a structural diagram of an electronic device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some but not all of the embodiments of this application. All other embodiments obtained by persons of ordinary skill in the art based on the embodiments of this application shall fall within the protection scope of this application.

The terms “first”, “second”, and the like in the specification and claims of this application are used to distinguish between similar objects rather than to describe a specific order or sequence. It should be understood that data used in this way is used interchangeably in appropriate circumstances so that the embodiments of this application can be implemented in other orders than the order illustrated or described herein. In addition, in the specification and claims, “and/or” indicates at least one of connected objects, and the character “/” generally indicates an “or” relationship between the contextually associated objects.

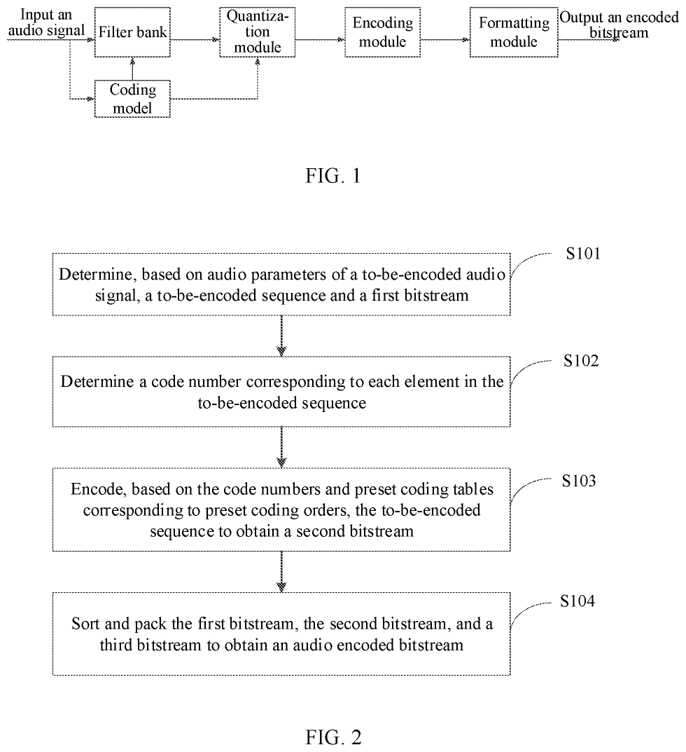

In the field of audio processing technologies, perceptual audio coding is generally used to encode audio signals, so as to compress the audio signals. Refer to FIG. 1. FIG. 1 is a schematic diagram of an application scenario of an audio encoding method according to an embodiment of this application. As shown in FIG. 1, in an application scenario of encoding audio signals, a to-be-encoded audio signal is input to a filter bank and a coding model to obtain a modified discrete cosine transform (MDCT) spectrum and a plurality of masking thresholds of the audio signal.

The filter may be a bank of filters, and the filter bank can convert the audio signal into a frequency domain signal, such that most of the energy of the audio signal is concentrated in some frequency bands to obtain the MDCT spectrum of the audio signal.

The coding model may be a psychoacoustic model. It should be understood that the psychoacoustic model is used to filter out signals in the audio signal that are imperceptible to human ears. The specific working principle is that an input audio signal is divided into a plurality of bands based on auditory perception characteristics of human ears and a masking threshold corresponding to each band is calculated.

The MDCT spectrum and the plurality of masking thresholds of the audio signal are input to a quantization module for quantization of the audio signal, and a global gain (GG) parameter corresponding to the audio signal and a scale factor (Scalefactor, scf) parameter corresponding to each band are obtained.

An optional implementation is that a value corresponding to the longest band in the audio signal is determined as the global gain parameter. The working principle of the quantization module can be briefly summarized as follows: a scale factor parameter is adjusted based on a global gain parameter and a masking threshold corresponding to each band, and the optimal scale factor parameter is used as a scale factor parameter corresponding to the band.

The global gain parameter corresponding to the audio signal and the scale factor parameter corresponding to each band are input to an encoding module for encoding, and an encoding result bitstream is formatted by a formatting module to obtain an audio encoded bitstream, so as to compress the audio signal.

In this step, an optional implementation is to encode the audio signal based on a probability distribution corresponding to each scale factor parameter. However, the probability distribution corresponding to each scale factor parameter is different. In the case of a plurality of scale factor parameters, the probability distribution corresponding to each scale factor parameter needs to be calculated, which leads to a low encoding efficiency.

Given the foregoing technical problem, an embodiment of this application provides an audio encoding method. The following describes in detail an audio encoding method according to an embodiment of this application through specific embodiments and application scenarios thereof with reference to the accompanying drawings.

Refer to FIG. 2. FIG. 2 is a flowchart of an audio encoding method according to an embodiment of this application. The audio encoding method provided in this embodiment of this application includes the following steps.

S101. Determine, based on audio parameters of a to-be-encoded audio signal, a to-be-encoded sequence and a first bitstream.

In this step, the audio parameters include a first parameter and a second parameter corresponding to each band of the audio signal. In a case that the audio signal has N bands, a quantity of the second parameters is N, N being a positive integer. Optionally, the first parameter may be a global gain parameter, and the second parameter may be a scale factor parameter. To clearly describe the technical solution, the first parameter and the second parameter mentioned in subsequent embodiments refer to a parameter value of the first parameter and a parameter value of the second parameter respectively.

The to-be-encoded sequence is obtained by encoding based on the first parameter and the N second parameters. For a specific technical solution, refer to the subsequent embodiments. The first bitstream is obtained by encoding based on the first parameter. For a specific technical solution, refer to the subsequent embodiments.

S102. Determine a code number corresponding to each element in the to-be-encoded sequence.

In this step, an absolute value of a value corresponding to each element in the to-be-encoded sequence can be determined as the code number corresponding to the element.

For example, the to-be-encoded sequence is {0,1,5,−8}, an absolute value corresponding to the first element 0 is 0, and 0 can be determined as the code number corresponding to the element. In this way, code numbers corresponding to the elements in the to-be-encoded sequence {0,1,5,−8} are {0,1,5,8}.

S103. Encode, based on the code numbers and preset coding tables corresponding to preset coding orders, the to-be-encoded sequence to obtain a second bitstream.

In this step, coding orders are preset, and the coding orders may be user-defined. Each coding order corresponds to a coding table, and the coding table reflects a mapping relationship between code numbers and code values.

In a possible case, there is one coding order, in which case there is one coding table corresponding to the coding order. In another possible case, there are a plurality of coding orders, in which case there are a plurality of coding tables corresponding to the coding orders. For example, there are five coding orders, in which case there are five coding tables.

Refer to Table 1. Table 1 shows a partial coding table corresponding to coding order 0 and a partial coding table corresponding to coding order 1.

TABLE 1

| | | Value | | | Value |
|---|---|---|---|---|---|
| | | range of | | | range of |
| Coding | Code | code | Coding | Code | code |
| order | value | number | order | value | number |
| K = 0 | 1 | 0 | K = 1 | 1X₀ | 0-1 |
| | 01X₀ | 1-2 | | 01X₁X₀ | 2-5 |
| | 001X₁X₀ | 3-6 | | 001X₂X₁X₀ | 6-13 |
| | 0001X₂X₁X₀ | 7-14 | | 0001X₃X₂X₁X₀ | 14-29 |

X₀, X₁, X₂, and X₃ in Table 1 may be 0 or 1.

For example, in a case that the coding order is 0, the code value corresponding to code number 1 is 010 and the code value corresponding to code number 2 is 011.

Based on the code numbers and the coding tables, the to-be-encoded sequence is encoded to obtain the second bitstream. For a specific technical solution, refer to the subsequent embodiments.

S104. Sort and pack the first bitstream, the second bitstream, and a third bitstream to obtain an audio encoded bitstream.

In this step, it should be noted that the third bitstream is an encoded bitstream obtained based on a magnitude relationship between each element in the to-be-encoded sequence and a first preset value. The first preset value may be 0, the third bitstream can be understood as a symbol sequence, and the positive or negative sign of each element in the to-be-encoded sequence can be determined based on the third bitstream.

An optional implementation is that in a to-be-encoded sequence, elements greater than 0 are assigned a value of 0 and elements less than 0 are assigned a value of 1. For a to-be-encoded sequence of {−1,5,−8,9}, a third bitstream {1,0,1,0} can be determined based on the positive or negative sign of each element.

Another optional implementation is that in a to-be-encoded sequence, elements greater than 0 are assigned a value of 0 and elements less than 0 are assigned a value of 1. For a to-be-encoded sequence of {−1,5,−8,9}, a third bitstream {1,0,1,0} can be determined based on the positive or negative sign of each element.

In this step, after the first bitstream, the second bitstream, and the third bitstream are obtained, the bitstreams are packed according to sorting to obtain the audio encoded bitstream. Optionally, an encoding order of the bitstreams in the audio encoded bitstream from left to right may be the first bitstream, the third bitstream, and the second bitstream.

In the embodiments of this application, the to-be-encoded sequence and the first bitstream are determined based on the audio parameters of the to-be-encoded audio signal; the code number corresponding to each element in the to-be-encoded sequence is determined; the to-be-encoded sequence is encoded based on the code numbers and the preset coding tables corresponding to the preset coding orders to obtain the second bitstream; and the first bitstream, the second bitstream, and the third bitstream are sorted and packed to obtain the audio encoded bitstream, where the third bitstream is the encoded bitstream obtained based on the magnitude relationship between each element in the to-be-encoded sequence and the first preset value. The audio encoding method provided in this embodiment of this application does not involve the calculation of the probability distributions of the audio parameters, so the audio signal does not need to be encoded based on the probability distributions of the audio parameters, which reduces a large amount of calculations, thereby improving the encoding efficiency.

The following specifically describes how the to-be-encoded sequence is encoded to obtain the second bitstream.

In a first case, the number of coding orders is 1, that is, there is only one coding order.

Optionally, the encoding, based on the code numbers and preset coding tables corresponding to preset coding orders, the to-be-encoded sequence to obtain a second bitstream includes:
determining a preset coding table corresponding to the coding order; for any code number, querying the coding table to obtain a code value corresponding to the code number; and sorting and packing all the code values to obtain the second bitstream.

In this embodiment, in the case of only one coding order, one coding table corresponding to the coding order is determined. For the code number corresponding to any element in the to-be-encoded sequence, because the foregoing coding table reflects the mapping between the code number and the code value, the coding table can be queried to obtain the code value corresponding to the code number.

Further, the coding table is queried for code values corresponding to all the elements in the to-be-encoded sequence, and all the code values are sorted and packed to obtain the second bitstream. It should be understood that the sorting of each code value in the second bitstream is the same as the sorting of the element corresponding to the code value in the to-be-encoded sequence.

For example, there is one coding order and the coding order is 0. Code numbers corresponding to the to-be-encoded sequence are {2,0,1,0,2} which can be obtained by querying Table 1. A code value corresponding to code number 0 is 1, a code value corresponding to code number 1 is 010, and a code value corresponding to code number 2 is 011, and thus a second bitstream {011,1,010,1,011} can be obtained.

In a second case, there are a plurality of coding orders.

It should be noted that in the case of a plurality of coding orders, the second bitstream includes a first sub-bitstream and a second sub-bitstream, where the second sub-bitstream is an encoded bitstream corresponding to K coding orders. For example, K is 2, and the coding orders are 1 and 2. In this case, binary numbers corresponding to the K coding orders can be packed to obtain the second sub-bitstream.

A binary number corresponding to 1 is 1 and a binary number corresponding to 2 is 10, so the second sub-bitstream is {1,110}.

Optionally, the encoding, based on the code numbers and preset coding tables corresponding to preset coding orders, the to-be-encoded sequence to obtain a second bitstream includes:
determining K preset coding tables corresponding to the K coding orders; for any code number, querying the K coding tables to obtain a target code value corresponding to the code number; and sorting and packing all the target code values to obtain the first sub-bitstream.

In this embodiment, in a case that there are K coding orders and K is greater than 1, a coding table corresponding to each coding order is determined, that is, K coding tables are determined.

For the code number corresponding to any element in the to-be-encoded sequence, all the coding tables are queried to obtain K code values corresponding to the code numbers, and a code value with the smallest code length among the K code values is determined as the target code value. Further, all the target code values are sorted and packed to obtain the second bitstream.

For example, there are two coding orders 0 and 1. Code numbers corresponding to the to-be-encoded sequence are {2,0,1,0,2} which can be obtained in Table 1. In a case that the coding order is 0, a code value corresponding to code number 0 is 1, a code value corresponding to code number 1 is 010, and a code value corresponding to code number 2 is 011. In a case that the coding order is 1, a code value corresponding to code number 0 is 10, a code value corresponding to code number 1 is 11, and a code value corresponding to code number 2 is 0100.

For code number 0, the code length of code value 1 is 1, and the code length of code value 10 is 2. Because 1 is less than 2, a target code value corresponding to code number 0 is 1. Based on the same principle, a target code value corresponding to code number 1 is 11 and a target code value corresponding to code number 2 is 011, and thus a second bitstream {011,1,11,1,011} can be obtained.

The following specifically describes how the to-be-encoded sequence and the first bitstream are determined. Optionally, the determining, based on audio parameters of a to-be-encoded audio signal, a to-be-encoded sequence and a first bitstream includes:
sorting and packing binary numbers corresponding to the first parameter to obtain the first bitstream; determining, based on the first parameter and sorting of the N second parameters, a first target value and N−1 arrays; and sorting and packing the first target value and N−1 second target values to obtain the to-be-encoded sequence.

In this embodiment, the binary numbers corresponding to the first parameter may be determined as the first bitstream. The binary numbers corresponding to the first parameter may be determined using binary encoding, Huffman coding, or other encoding manners.

In this embodiment, the following two manners can be used to obtain the to-be-encoded sequence.

The first manner is as follows: Backward difference is performed on a first parameter and N second parameters to obtain a first target value and N−1 second target values, and the first target value and the N−1 second target values are sorted and packed to obtain a to-be-encoded sequence.

In a specific implementation, based on the sorting of the N second parameters, the first parameter is subtracted from a second parameter sorted first to obtain a first target parameter. Two adjacent second parameters in the N second parameters are taken as an array, and based on the N second parameters, N−1 arrays can be obtained. In each array, a second parameter sorted earlier is subtracted from a second parameter sorted later to obtain N−1 second target values.

For example, the first parameter is 66, and there are three second parameters which are 67, 68, and 66 respectively. In the foregoing implementation, the first target value is value 1 of 67 minus 66. Two second target values can be obtained, which are value 1 of 68 minus 67 and value −2 of 66 minus 68 respectively. Then, the to-be-encoded sequence is {1,1,−2}.

The second manner is as follows: Forward difference is performed on a first parameter and N second parameters to obtain a first target value and N−1 second target values, and the first target value and the N−1 second target values are sorted and packed to obtain a to-be-encoded sequence.

In a specific implementation, based on the sorting of the N second parameters, a second parameter sorted first is subtracted from the first parameter to obtain a first target parameter. Two adjacent second parameters in the N second parameters are taken as an array, and based on the N second parameters, N−1 arrays can be obtained. In each array, a second parameter sorted later is subtracted from a second parameter sorted earlier to obtain N−1 second target values.

For example, the first parameter is 66, and there are three second parameters which are 67, 68, and 66 respectively. In the foregoing implementation, the first target value is value −1 of 66 minus 67. Two second target values can be obtained, which are value −1 of 67 minus 68 and value 2 of 68 minus 66 respectively. Then, the to-be-encoded sequence is {−1,−1,2}.

For ease of detailed description of the audio encoding method provided in this application, an example in which the first parameter is 68 and there are 24 second parameters and coding order 0 is used for description.

Given that the second parameters are:
{66,66,66,66,66,66,65,65,66,64,64,65,66,66,66,65,66,66,66,68,66,66,66,65}.

A first bitstream is binary numbers corresponding to the first parameter, {01000100}.

First parameter 68 is subtracted from second parameter 66 sorted first to obtain first target value −2. The method described in the foregoing embodiment is used to perform backward difference on the first parameter and the N second parameters to obtain a to-be-encoded sequence: {−2,0,0,0,0,0,−1,0,1,−2,0,1,1,0,0,−1,1,0,0,2,−2,0,0,−1}.

Based on a magnitude relationship between each element in the to-be-encoded sequence and a first preset value, a third bitstream is obtained: {1,0,0,0,0,0,1,0,0,1,0,0,0,0,0,1,0,0,0,0,1,0,0,1}.

Code numbers corresponding to the elements in the to-be-encoded sequence are determined as:
{2,0,0,0,0,0,1,0,1,2,0,1,1,0,0,1,1,0,0,2,2,0,0,1}.

In a case that the coding order is 0, the code value corresponding to each code number is determined by referring to the coding table shown in Table 1, and then a second bitstream is determined as:
{011,1,1,1,1,1,010,1,010,011,1,010,010,1,1,010,010,1,1,011,011,1,1,010}.

The first bitstream, the second bitstream, and the third bitstream are sorted and packed to obtain an audio encoded bitstream:
{01000100,100000100100000100001001,01111111010101001110100101101001011011 01111010}.

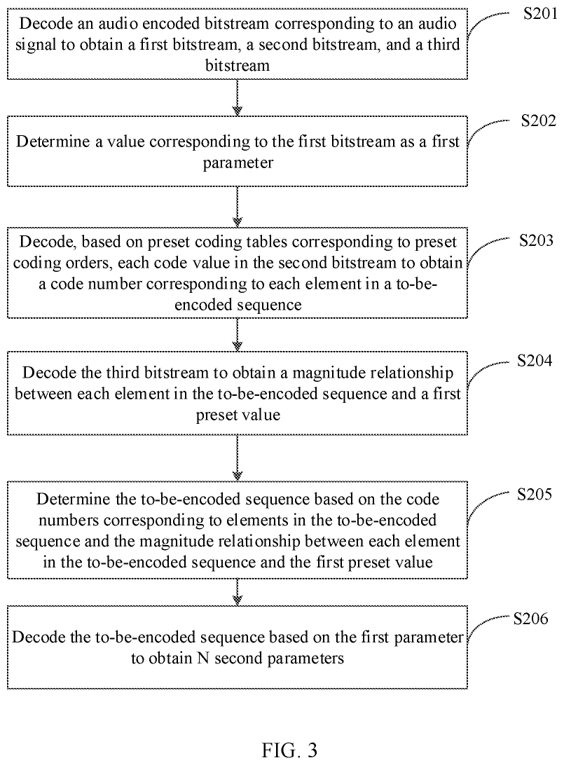

Refer to FIG. 3. FIG. 3 is a flowchart of an audio decoding method according to an embodiment of this application. The audio decoding method provided in this embodiment of this application includes the following steps.

S201. Decode an audio encoded bitstream corresponding to an audio signal to obtain a first bitstream, a second bitstream, and a third bitstream.

In this step, it should be noted that in the audio encoded bitstream, coding positions for the first bitstream, the second bitstream, and the third bitstream are preset respectively, so that the audio encoded bitstream can be decoded to obtain the first bitstream, the second bitstream, and the third bitstream.

S202. Determine a value corresponding to the first bitstream as a first parameter.

In this step, an optional implementation is that a decimal number corresponding to the first bitstream is determined as the first parameter.

S203. Decode, based on preset coding tables corresponding to preset coding orders, each code value in the second bitstream to obtain a code number corresponding to each element in a to-be-encoded sequence.

In this step, coding orders are preset, and the coding orders may be user-defined. Each coding order corresponds to a coding table, and the coding table reflects a mapping relationship between code numbers and code values.

In the case of one coding order, the only one coding table is queried to obtain a code number corresponding to each code value in the second bitstream. In the case of a plurality of coding orders, a plurality of coding tables are queried to obtain a code number corresponding to each code value in the second bitstream, and a set of code number sequences consisting of code numbers are obtained. For a specific technical solution, refer to subsequent embodiments.

S204. Decode the third bitstream to obtain a magnitude relationship between each element in the to-be-encoded sequence and a first preset value.

In this step, each element in the third bitstream reflects a magnitude relationship between a corresponding code number and the first preset value, and thus the third bitstream can be decoded. In an implementation, binary number 1 in the third bitstream can be decoded as a positive sign and binary number 0 in the third bitstream can be decoded as a negative sign to obtain a set of symbol sequences.

S205. Determine the to-be-encoded sequence based on the code numbers corresponding to elements in the to-be-encoded sequence and the magnitude relationship between each element in the to-be-encoded sequence and the first preset value.

In this step, for any element in the to-be-encoded sequence, the element is generated based on the corresponding code number and the magnitude relationship between the element and the first preset value. The symbol sequences and the code number sequences can be multiplied to obtain the to-be-encoded sequence.

S206. Decode the to-be-encoded sequence based on the first parameter to obtain N second parameters.

In this step, the N second parameters are determined based on the sorting of the elements in the to-be-encoded sequence, so as to obtain the first parameter and the N second parameters to decode the audio encoded bitstream.

An optional implementation is that a sum of an element sorted first in the to-be-encoded sequence and the first parameter is determined as a second parameter sorted first, and a sum of the second parameter sorted first and an element sorted second in the to-be-encoded sequence is determined as a second parameter sorted second. Based on the foregoing principle, the N second parameters are obtained.

Another optional implementation is that a value of an element sorted first in the to-be-encoded sequence subtracted from the first parameter is determined as a second parameter sorted first, and a difference between the second parameter sorted first and an element sorted second in the to-be-encoded sequence is determined as a second parameter sorted second. Based on the foregoing principle, the N second parameters are obtained.

Optionally, the decoding, based on preset coding tables corresponding to preset coding orders, each code value in the second bitstream to obtain a code number corresponding to each element in a to-be-encoded sequence includes:
determining a preset coding table corresponding to the coding order; and for any code value in the second bitstream, determining a code number corresponding to the code value obtained by querying the coding table as a code number for an element corresponding to the code value in the to-be-encoded sequence.

In this embodiment, in the case of only one coding order, one coding table corresponding to the coding order is determined. For any code value in the second bitstream, because the foregoing coding table reflects the mapping between the code number and the code value, the code number corresponding to the code value can be obtained by querying the coding table.

Optionally, the decoding, based on preset coding tables corresponding to preset coding orders, each code value in the second bitstream to obtain a code number corresponding to each element in a to-be-encoded sequence includes:
determining K preset coding tables corresponding to K coding orders; and for any code value in a first sub-bitstream, determining a code number corresponding to the code value obtained by querying the K coding tables as a code number for an element corresponding to the code value in the to-be-encoded sequence.

In this embodiment, in a case that there are K coding orders and K is greater than 1, the second bitstream includes a first sub-bitstream and a second sub-bitstream, where the second sub-bitstream is an encoded bitstream corresponding to K coding orders.

It should be understood that each coding table reflects a different code value, and in the case of a plurality of coding orders, for any code value in the second bitstream, the code number corresponding to the code value can be obtained by querying the K coding tables.

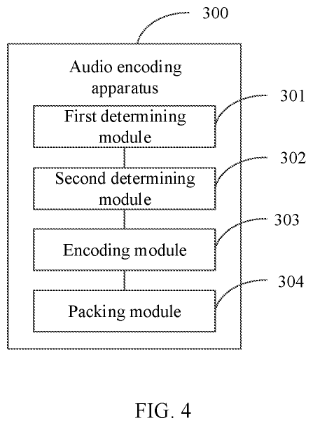

As shown in FIG. 4, an audio encoding apparatus 300 includes:
a first determining module 301 configured to determine, based on audio parameters of a to-be-encoded audio signal, a to-be-encoded sequence and a first bitstream;
a second determining module 302 configured to determine a code number corresponding to each element in the to-be-encoded sequence;
an encoding module 303 configured to encode, based on the code numbers and preset coding tables corresponding to preset coding orders, the to-be-encoded sequence to obtain a second bitstream; and
a packing module 304 configured to sort and pack the first bitstream, the second bitstream, and a third bitstream to obtain an audio encoded bitstream.

Optionally, the encoding module 303 is further configured to:
determine a preset coding table corresponding to the coding order;
for any code number, query the coding table to obtain a code value corresponding to the code number; and
sort and pack all the code values to obtain the second bitstream.

Optionally, the encoding module 303 is further configured to:
determine K preset coding tables corresponding to K coding orders;
for any code number, query the K coding tables to obtain a target code value corresponding to the code number; and
sort and pack all the target code values to obtain a first sub-bitstream.

Optionally, the first determining module 301 is further configured to:
sort and pack binary numbers corresponding to a first parameter to obtain the first bitstream;
determine, based on the first parameter and sorting of N second parameters, a first target value and N−1 arrays; and
sort and pack the first target value and N−1 second target values to obtain the to-be-encoded sequence.

The audio encoding apparatus in this embodiment of this application may be a mobile terminal, or may be a component, an integrated circuit, or a chip in a terminal. The apparatus may be a mobile electronic device or a non-mobile electronic device. For example, the mobile electronic device may be a mobile phone, a tablet computer, a notebook computer, a palmtop computer, a vehicle-mounted electronic device, a wearable device, an ultra-mobile personal computer (UMPC), a netbook, a personal digital assistant (PDA), or the like, and the non-mobile electronic device may be a server, a network attached storage (NAS), a personal computer (PC), a television (TV), a teller machine, a self-service machine, or the like. This is not specifically limited in the embodiments of this application.

The audio encoding apparatus in this embodiment of this application may be an apparatus with an operating system. The operating system may be an Android operating system, an iOS operating system, or another possible operating system. This is not specifically limited in the embodiments of this application.

The audio encoding apparatus provided in this embodiment of this application can implement the processes implemented by the audio encoding method in the method embodiment in FIG. 2. To avoid repetition, details are not described herein again.

This embodiment of this application does not involve the calculation of the probability distributions of the audio parameters, so the audio signal does not need to be encoded based on the probability distributions of the audio parameters, which reduces a large amount of calculations, thereby improving the encoding efficiency.

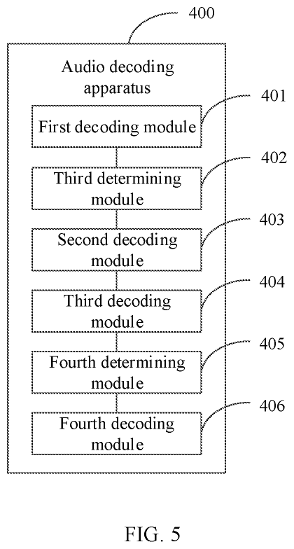

Optionally, an embodiment of this application further provides an audio decoding apparatus 400. As shown in FIG. 5, the audio decoding apparatus 400 includes:
a first decoding module 401 configured to decode an audio encoded bitstream corresponding to an audio signal to obtain a first bitstream, a second bitstream, and a third bitstream;
a third determining module 402 configured to determine a value corresponding to the first bitstream as a first parameter;
a second decoding module 403 configured to decode, based on preset coding tables corresponding to preset coding orders, each code value in the second bitstream to obtain a code number corresponding to each element in a to-be-encoded sequence;
a third decoding module 404 configured to decode the third bitstream to obtain a magnitude relationship between each element in the to-be-encoded sequence and a first preset value;
a fourth determining module 405 configured to determine the to-be-encoded sequence based on the code numbers corresponding to elements in the to-be-encoded sequence and the magnitude relationship between each element in the to-be-encoded sequence and the first preset value; and
a fourth decoding module 406 configured to decode the to-be-encoded sequence based on the first parameter to obtain N second parameters.

Optionally, the second decoding module 403 is further configured to:
determine a preset coding table corresponding to the coding order; and
for any code value in the second bitstream, determine a code number corresponding to the code value obtained by querying the coding table as a code number for an element corresponding to the code value in the to-be-encoded sequence.

Optionally, the second decoding module 403 is further configured to:
determine K preset coding tables corresponding to K coding orders; and
for any code value in the first sub-bitstream, determine a code number corresponding to the code value obtained by querying the K coding tables as a code number for an element corresponding to the code value in the to-be-encoded sequence.

The audio decoding apparatus in this embodiment of this application may be a mobile terminal, or may be a component, an integrated circuit, or a chip in a terminal. The apparatus may be a mobile electronic device or a non-mobile electronic device. For example, the mobile electronic device may be a mobile phone, a tablet computer, a notebook computer, a palmtop computer, a vehicle-mounted electronic device, a wearable device, an ultra-mobile personal computer (UMPC), a netbook, a personal digital assistant (PDA), or the like, and the non-mobile electronic device may be a server, a network attached storage (NAS), a personal computer (PC), a television (TV), a teller machine, a self-service machine, or the like. This is not specifically limited in the embodiments of this application.

The audio decoding apparatus in this embodiment of this application may be an apparatus with an operating system. The operating system may be an Android operating system, an iOS operating system, or another possible operating system. This is not specifically limited in the embodiments of this application.

The audio decoding apparatus provided in this embodiment of this application can implement the processes implemented by the audio decoding method in the method embodiment in FIG. 3. To avoid repetition, details are not described herein again.

Optionally, an embodiment of this application further provides an electronic device including a processor 510, a memory 509, and a program or instructions stored in the memory 509 and capable of running on the processor 510, where when the program or instructions are executed by the processor 510, the processes of the foregoing embodiments of the audio encoding method are implemented, with the same technical effects achieved. To avoid repetition, details are not described herein again.

When the program or instructions are executed by the processor 510, the processes of the foregoing embodiments of the audio decoding method are also implemented, with the same technical effects achieved. To avoid repetition, details are not described herein again.

It should be noted that the electronic device in this embodiment of this application includes the foregoing mobile electronic devices and non-mobile electronic devices.

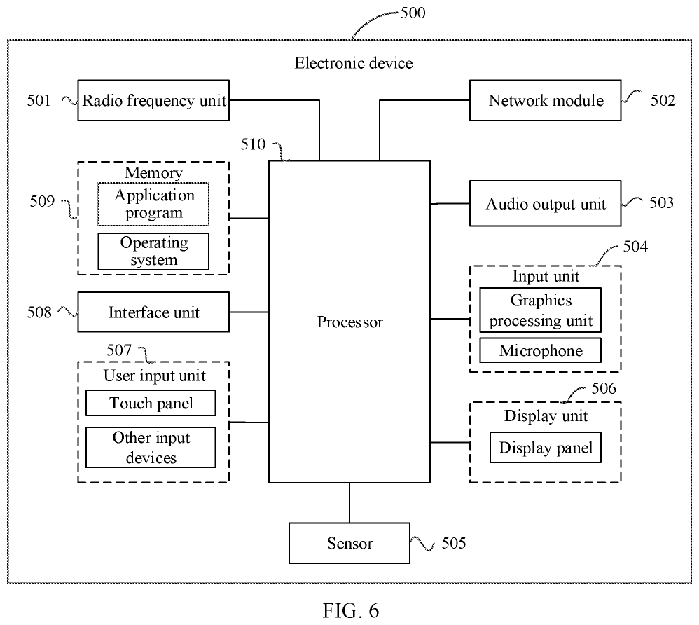

FIG. 6 is a schematic diagram of a hardware structure of an electronic device according to an embodiment of this application.

The electronic device 500 includes but is not limited to components such as a radio frequency unit 501, a network module 502, an audio output unit 505, an input unit 504, a sensor 505, a display unit 506, a user input unit 507, an interface unit 508, a memory 509, and a processor 510.

Persons skilled in the art can understand that the electronic device 500 may further include a power supply (for example, battery) for supplying power to the components. The power supply may be logically connected to the processor 510 via a power management system, so that functions such as charge management, discharge management, and power consumption management are implemented via the power management system. The structure of the electronic device shown in FIG. 6 does not constitute any limitation on the electronic device. The electronic device may include more or fewer components than shown in the figure, or combine some of the components, or arrange the components differently. Details are not described herein.

The processor 510 is configured to determine, based on audio parameters of a to-be-encoded audio signal, a to-be-encoded sequence and a first bitstream;
determine a code number corresponding to each element in the to-be-encoded sequence;
encode, based on the code numbers and preset coding tables corresponding to preset coding orders, the to-be-encoded sequence to obtain a second bitstream; and
sort and pack the first bitstream, the second bitstream, and a third bitstream to obtain an audio encoded bitstream.

This embodiment of this application does not involve the calculation of the probability distributions of the audio parameters, so the audio signal does not need to be encoded based on the probability distributions of the audio parameters, which reduces a large amount of calculations, thereby improving the encoding efficiency.

The processor 510 is further configured to decode an audio encoded bitstream corresponding to an audio signal to obtain a first bitstream, a second bitstream, and a third bitstream;
determine a value corresponding to the first bitstream as a first parameter;
decode, based on preset coding tables corresponding to preset coding orders, each code value in the second bitstream to obtain a code number corresponding to each element in a to-be-encoded sequence;
decode the third bitstream to obtain a magnitude relationship between each element in the to-be-encoded sequence and a first preset value;
determine the to-be-encoded sequence based on the code numbers corresponding to elements in the to-be-encoded sequence and the magnitude relationship between each element in the to-be-encoded sequence and the first preset value; and
decode the to-be-encoded sequence based on the first parameter to obtain N second parameters.

An embodiment of this application further provides a readable storage medium, where the readable storage medium may be non-volatile or volatile. The readable storage medium stores a program or instructions, and when the program or instructions are executed by a processor, the processes of the foregoing embodiments of the audio encoding method are implemented, or the processes of the foregoing embodiments of the audio decoding method are implemented, with the same technical effects achieved. To avoid repetition, details are not described herein again.

The processor is a processor in the electronic device in the foregoing embodiment. The readable storage medium includes a computer-readable storage medium, for example, a computer read-only memory (ROM), a random access memory (RAM), a magnetic disk, or an optical disc.

An embodiment of this application further provides a chip. The chip includes a processor and a communications interface. The communications interface is coupled to the processor, and the processor is configured to run a program or instructions to implement the processes of the foregoing embodiments of the audio encoding method or the processes of the foregoing embodiments of the audio decoding method, with the same technical effects achieved. To avoid repetition, details are not described herein again.

It should be understood that the chip mentioned in this embodiment of this application may also be referred to as a system-level chip, a system chip, a chip system, a system-on-chip, or the like.

An embodiment of this application further provides a computer program product, where the computer program product is stored in a non-transitory readable storage medium, and the computer program product is executed by at least one processor to implement the processes of the foregoing embodiments of the audio decoding method, with the same technical effects achieved. To avoid repetition, details are not described herein again.

It should be noted that in this specification, the terms “include”, “comprise”, or any of their variants are intended to cover a non-exclusive inclusion, such that a process, method, article, or apparatus that includes a series of elements not only includes those elements but also includes other elements that are not expressly listed, or further includes elements inherent to such process, method, article, or apparatus. Without more restrictions, an element preceded by the statement “includes a . . . ” does not preclude the presence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

From the foregoing description of the implementations, persons skilled in the art can clearly understand that the method in the foregoing embodiments may be implemented by software in combination with a necessary general hardware platform. Certainly, the method in the foregoing embodiments may alternatively be implemented by hardware. However, in many cases, the former is a preferred implementation. Based on such understanding, the technical solutions of this application essentially or the part thereof that contributes to the prior art may be implemented in a form of a software product. The computer software product is stored in a storage medium (for example, ROM/RAM, a magnetic disk, or an optical disc), and includes several instructions for instructing a terminal (which may be a mobile phone, a computer, a server, an air conditioner, a network device, or the like) to perform the method described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms which do not depart from the essence of this application and the protection scope of the claims, and all such forms shall fall within the protection scope of this application.

What is claimed is:

1. An audio encoding method, comprising
determining, based on audio parameters of a to-be-encoded audio signal, a to-be-encoded sequence and a first bitstream, wherein the audio parameters comprise a first parameter and N second parameters, N being a positive integer, the first bitstream is obtained by encoding based on the first parameter, and the to-be-encoded sequence is obtained by encoding based on the first parameter and the N second parameters;
determining a code number corresponding to each element in the to-be-encoded sequence;
encoding, based on the code numbers and preset coding tables corresponding to preset coding orders, the to-be-encoded sequence to obtain a second bitstream; and
sorting and packing the first bitstream, the second bitstream, and a third bitstream to obtain an audio encoded bitstream, wherein
the third bitstream is an encoded bitstream obtained based on a magnitude relationship between each element in the to-be-encoded sequence and a first preset value.

2. The method according to claim 1, wherein the number of coding orders is K, and in a case that K is equal to 1, the encoding, based on the code numbers and preset coding tables corresponding to preset coding orders, the to-be-encoded sequence to obtain a second bitstream comprises:
determining a preset coding table corresponding to the coding order, the coding table comprising a mapping relationship between code numbers and code values;
for any code number, querying the coding table to obtain a code value corresponding to the code number; and
sorting and packing all the code values to obtain the second bitstream.

3. The method according to claim 1, wherein the number of coding orders is K, and in a case that K is greater than 1, the second bitstream comprises a first sub-bitstream and a second sub-bitstream, the second sub-bitstream is an encoded bitstream corresponding to K coding orders, and the encoding, based on the code numbers and preset coding tables corresponding to preset coding orders, the to-be-encoded sequence to obtain a second bitstream comprises:
determining K preset coding tables corresponding to the K coding orders, wherein the coding tables and the coding orders are in one-to-one correspondence, and the coding table comprises a mapping relationship between code numbers and code values;
for any code number, querying the K coding tables to obtain a target code value corresponding to the code number, the target code value being a code value with the smallest code length among K code values obtained by querying the K coding tables; and
sorting and packing all the target code values to obtain the first sub-bitstream.

4. The method according to claim 1, wherein the determining, based on audio parameters of a to-be-encoded audio signal, a to-be-encoded sequence and a first bitstream comprises:
sorting and packing binary numbers corresponding to the first parameter to obtain the first bitstream;
determining, based on the first parameter and sorting of the N second parameters, a first target value and N−1 arrays, the first target value being generated based on the second parameter sorted first and the first parameter, and each of the arrays comprising two adjacent second parameters; and
sorting and packing the first target value and N−1 second target values to obtain the to-be-encoded sequence, each of the second target values being generated based on two adjacent second parameters in a corresponding array, and the first target value being sorted first in the to-be-encoded sequence.

5. An audio decoding method, comprising:
decoding an audio encoded bitstream corresponding to an audio signal to obtain a first bitstream, a second bitstream, and a third bitstream, wherein audio parameters of the audio signal comprise a first parameter and N second parameters, N being a positive integer, and the first bitstream is obtained by encoding based on the first parameter;
determining a value corresponding to the first bitstream as the first parameter;
decoding, based on preset coding tables corresponding to preset coding orders, each code value in the second bitstream to obtain a code number corresponding to each element in a to-be-encoded sequence, the to-be-encoded sequence being obtained by encoding based on the first parameter and the N second parameters;
decoding the third bitstream to obtain a magnitude relationship between each element in the to-be-encoded sequence and a first preset value;
determining the to-be-encoded sequence based on the code numbers corresponding to elements in the to-be-encoded sequence and the magnitude relationship between each element in the to-be-encoded sequence and the first preset value; and
decoding the to-be-encoded sequence based on the first parameter to obtain the N second parameters.

6. The method according to claim 5, wherein the number of coding orders is K, and in a case that K is equal to 1, the decoding, based on preset coding tables corresponding to preset coding orders, each code value in the second bitstream to obtain a code number corresponding to each element in a to-be-encoded sequence comprises:
determining a preset coding table corresponding to the coding order, the coding table comprising a mapping relationship between code numbers and code values; and
for any code value in the second bitstream, determining a code number corresponding to the code value obtained by querying the coding table as a code number for an element corresponding to the code value in the to-be-encoded sequence.

7. The method according to claim 5, wherein the number of coding orders is K, and in a case that K is greater than 1, the second bitstream comprises a first sub-bitstream and a second sub-bitstream, the second sub-bitstream is an encoded bitstream corresponding to K coding orders, and the decoding, based on preset coding tables corresponding to preset coding orders, each code value in the second bitstream to obtain a code number corresponding to each element in a to-be-encoded sequence comprises:
determining K preset coding tables corresponding to the K coding orders, wherein the coding tables and the coding orders are in one-to-one correspondence, and the coding table comprises a mapping relationship between code numbers and code values; and
for any code value in the first sub-bitstream, determining a code number corresponding to the code value obtained by querying the K coding tables as a code number for an element corresponding to the code value in the to-be-encoded sequence.

8. An electronic device, comprising a processor, a memory, and a program or instructions stored in the memory and capable of running on the processor, wherein when the program or instructions are executed by the processor, following steps are implemented:
determining, based on audio parameters of a to-be-encoded audio signal, a to-be-encoded sequence and a first bitstream, wherein the audio parameters comprise a first parameter and N second parameters, N being a positive integer, the first bitstream is obtained by encoding based on the first parameter, and the to-be-encoded sequence is obtained by encoding based on the first parameter and the N second parameters;
determining a code number corresponding to each element in the to-be-encoded sequence;
encoding, based on the code numbers and preset coding tables corresponding to preset coding orders, the to-be-encoded sequence to obtain a second bitstream; and
sorting and packing the first bitstream, the second bitstream, and a third bitstream to obtain an audio encoded bitstream, wherein
the third bitstream is an encoded bitstream obtained based on a magnitude relationship between each element in the to-be-encoded sequence and a first preset value.

9. The electronic device according to claim 8, wherein the number of coding orders is K, and in a case that K is equal to 1, the encoding, based on the code numbers and preset coding tables corresponding to preset coding orders, the to-be-encoded sequence to obtain a second bitstream comprises:
determining a preset coding table corresponding to the coding order, the coding table comprising a mapping relationship between code numbers and code values;
for any code number, querying the coding table to obtain a code value corresponding to the code number; and
sorting and packing all the code values to obtain the second bitstream.

10. The electronic device according to claim 8, wherein the number of coding orders is K, and in a case that K is greater than 1, the second bitstream comprises a first sub-bitstream and a second sub-bitstream, the second sub-bitstream is an encoded bitstream corresponding to K coding orders, and the encoding, based on the code numbers and preset coding tables corresponding to preset coding orders, the to-be-encoded sequence to obtain a second bitstream comprises:
determining K preset coding tables corresponding to the K coding orders, wherein the coding tables and the coding orders are in one-to-one correspondence, and the coding table comprises a mapping relationship between code numbers and code values;
for any code number, querying the K coding tables to obtain a target code value corresponding to the code number, the target code value being a code value with the smallest code length among K code values obtained by querying the K coding tables; and
sorting and packing all the target code values to obtain the first sub-bitstream.

11. The electronic device according to claim 8, wherein the determining, based on audio parameters of a to-be-encoded audio signal, a to-be-encoded sequence and a first bitstream comprises:
sorting and packing binary numbers corresponding to the first parameter to obtain the first bitstream;
determining, based on the first parameter and sorting of the N second parameters, a first target value and N−1 arrays, the first target value being generated based on the second parameter sorted first and the first parameter, and each of the arrays comprising two adjacent second parameters; and
sorting and packing the first target value and N−1 second target values to obtain the to-be-encoded sequence, each of the second target values being generated based on two adjacent second parameters in a corresponding array, and the first target value being sorted first in the to-be-encoded sequence.

12. An electronic device, comprising a processor, a memory, and a program or instructions stored in the memory and capable of running on the processor, wherein when the program or instructions are executed by the processor, the steps of the method according to claim 5 are implemented.

13. The electronic device according to claim 12, wherein the number of coding orders is K, and in a case that K is equal to 1, the decoding, based on preset coding tables corresponding to preset coding orders, each code value in the second bitstream to obtain a code number corresponding to each element in a to-be-encoded sequence comprises:
determining a preset coding table corresponding to the coding order, the coding table comprising a mapping relationship between code numbers and code values; and
for any code value in the second bitstream, determining a code number corresponding to the code value obtained by querying the coding table as a code number for an element corresponding to the code value in the to-be-encoded sequence.

14. The electronic device according to claim 12, wherein the number of coding orders is K, and in a case that K is greater than 1, the second bitstream comprises a first sub-bitstream and a second sub-bitstream, the second sub-bitstream is an encoded bitstream corresponding to K coding orders, and the decoding, based on preset coding tables corresponding to preset coding orders, each code value in the second bitstream to obtain a code number corresponding to each element in a to-be-encoded sequence comprises:
determining K preset coding tables corresponding to the K coding orders, wherein the coding tables and the coding orders are in one-to-one correspondence, and the coding table comprises a mapping relationship between code numbers and code values; and
for any code value in the first sub-bitstream, determining a code number corresponding to the code value obtained by querying the K coding tables as a code number for an element corresponding to the code value in the to-be-encoded sequence.

15. A non-transitory readable storage medium, wherein the non-transitory readable storage medium stores a program or instructions, and when the program or instructions are executed by a processor, the steps of the method according to claim 1 are implemented.

16. The non-transitory readable storage medium according to claim 15, wherein the number of coding orders is K, and in a case that K is equal to 1, the encoding, based on the code numbers and preset coding tables corresponding to preset coding orders, the to-be-encoded sequence to obtain a second bitstream comprises:
determining a preset coding table corresponding to the coding order, the coding table comprising a mapping relationship between code numbers and code values;
for any code number, querying the coding table to obtain a code value corresponding to the code number; and
sorting and packing all the code values to obtain the second bitstream.

17. The non-transitory readable storage medium according to claim 15, wherein the number of coding orders is K, and in a case that K is greater than 1, the second bitstream comprises a first sub-bitstream and a second sub-bitstream, the second sub-bitstream is an encoded bitstream corresponding to K coding orders, and the encoding, based on the code numbers and preset coding tables corresponding to preset coding orders, the to-be-encoded sequence to obtain a second bitstream comprises:
determining K preset coding tables corresponding to the K coding orders, wherein the coding tables and the coding orders are in one-to-one correspondence, and the coding table comprises a mapping relationship between code numbers and code values;
for any code number, querying the K coding tables to obtain a target code value corresponding to the code number, the target code value being a code value with the smallest code length among K code values obtained by querying the K coding tables; and
sorting and packing all the target code values to obtain the first sub-bitstream.

18. The non-transitory readable storage medium according to claim 15, wherein the determining, based on audio parameters of a to-be-encoded audio signal, a to-be-encoded sequence and a first bitstream comprises:
sorting and packing binary numbers corresponding to the first parameter to obtain the first bitstream;
determining, based on the first parameter and sorting of the N second parameters, a first target value and N−1 arrays, the first target value being generated based on the second parameter sorted first and the first parameter, and each of the arrays comprising two adjacent second parameters; and
sorting and packing the first target value and N−1 second target values to obtain the to-be-encoded sequence, each of the second target values being generated based on two adjacent second parameters in a corresponding array, and the first target value being sorted first in the to-be-encoded sequence.

19. A non-transitory readable storage medium, wherein the non-transitory readable storage medium stores a program or instructions, and when the program or instructions are executed by a processor, the steps of the method according to claim 5 are implemented.

20. The non-transitory readable storage medium according to claim 19, wherein the number of coding orders is K, and in a case that K is equal to 1, the decoding, based on preset coding tables corresponding to preset coding orders, each code value in the second bitstream to obtain a code number corresponding to each element in a to-be-encoded sequence comprises:
determining a preset coding table corresponding to the coding order, the coding table comprising a mapping relationship between code numbers and code values; and
for any code value in the second bitstream, determining a code number corresponding to the code value obtained by querying the coding table as a code number for an element corresponding to the code value in the to-be-encoded sequence.
